(19) United States
(12) Patent Application Publication
(10) Pub. No.: US 2025/0385412 A1
(43) Pub. Date: Dec. 18, 2025

(54) A WAVEGUIDE ADAPTER

(71) Applicant: TeraSi AB, Värmdö (SE)

(72) Inventors: James CAMPION, Värmdö (SE); Bernhard BEUERLE, Solna (SE)

(73) Assignee: TeraSi AB, Värmdö (SE)

(21) Appl. No.: 18/877,586

(22) PCT Filed: Jun. 21, 2023
(86) PCT No.: PCT/EP2023/066855

§ 371 Date: Dec. 20, 2024

(30) Foreign Application Priority Data
Jun. 21, 2022 (SE) 2250760-2

(51) Int. Cl. H01P 1/04; H01P 11/00

(52) U.S. Cl. CPC H01P 1/042; H01P 11/00

(57) ABSTRACT

The invention relates to a waveguide adapter for mounting on the flange of a waveguide for adapting the flange to connect to another waveguide or an external device as well as to ensure precise alignment and proper connection between the waveguide and another waveguide or external device. The adapter comprises two sides, and either side may be used to mate the flange, so that the side of the adapter facing outward from the waveguide may be flat, have a protrusion or have a recess. The outward facing side may then mate to a surface of another waveguide adapter, another waveguide or another external device.

### FIELD OF THE INVENTION

The present invention relates to a waveguide adapter for mounting on the flange of a waveguide for adapting the flange to connect to another waveguide or an external device, as well as to reduce the electrical degradation caused by gabs.

### BACKGROUND OF THE INVENTION

Waveguides are usually manufactured in solid materials, with metals as the most prevalent. At high frequencies, above 100 GHz, manufacturing tolerances greatly degrade the mechanical precision and electrical performance of the waveguides. When connecting two waveguides in series the flange from one waveguide is abutting a flange of the other waveguide. This requires that both waveguides be mechanically aligned and connected to one another. This necessitates the use of specific alignment and connection features, the precision of which directly impacts the electrical performance of the resulting connection. In addition, there may be small irregularities in the surface of the flanges due to the insufficient mechanical precision in the manufacturing, and this may cause rocking, cocking or tilting of the waveguides as well as create gaps between their interfaces, which is undesirable as it may degrade the electrical performance, as the connection may not be in as good electrically contact as required to obtain a desirable electrical performance.

Further, waveguides are manufactured in different forms with different mechanical interfaces, so that the interface of one waveguide may not fit the interface of another waveguide or external device, which the waveguide is supposed to connect to, which may reduce the connectability of the waveguide to other waveguides or external device.

Hence, an improved connecting interface would be advantageous, for a waveguide to be able to connect to another waveguide or an external device and in particular, implementing an interface with more precise alignment features and connection surfaces would be advantageous to improve the electrical performance of the waveguides.

### OBJECT OF THE INVENTION

It is an object of the present invention to provide a waveguide adapter for adapting the flange of a waveguide to improve the connectability and alignment to another waveguide or an external device.

Further, it is an object of the present invention to provide a waveguide adapter to ensure a connection to another waveguide or an external device to reduce rocking, cocking or tilting of the waveguides

It is further an object of the present invention provide an interface which eliminates or at least reduces the electrical degradation caused by any gaps between a waveguide and another waveguide or another external device.

It is a further object of the present invention to provide an alternative to the prior art.

In particular, it may be seen as an object of the present invention to provide a waveguide component that solves the above-mentioned problems of the prior art.

### SUMMARY OF THE INVENTION

Thus, the above-described object and several other objects are intended to be obtained in a first aspect of the invention by providing a waveguide adapter for mounting on a flange of a waveguide. The waveguide adapter comprises a first side and a second side, the first side comprises a first contact surface and the second side comprises a second contact surface, wherein when mounted on the waveguide, either the first contact surface or the second contact surface is configured to mate with the flange, the waveguide adapter comprises a first layer and a second layer, the first layer comprises the first contact surface and the second contact surface, the second layer is fixed to the first layer and comprises a protrusion on the second side of the waveguide adapter, and the waveguide adapter further comprises a waveguide opening to be aligned with a waveguide channel in the waveguide.

The waveguide adapter is intended for mounting on the flange of a waveguide to adapt the waveguide to connect to another waveguide or an external device to obtain precise alignment and proper connection. The flange comprises an interface, which is intended to be a contact interface for other waveguides or for external devises to interface with. This interface is changed and improved by mounting the waveguide adapter on the flange mating the interface, so that the waveguide adapter will form the interface for other devices, like another waveguide to interface with.

The waveguide adapter is a non-contact interface, preventing direct contact between the flange of the waveguide and the flange of another device. Further, the waveguide adapter makes it possible to adapt the waveguide to be able to interface to another waveguide or an external device that the waveguide otherwise would not be able to connect to.

The waveguide adapter is intended for eliminating the need for physical contact between the flanges of the waveguide and another device, the adapter allows a non-contact interface to be formed, eliminating the need to mechanically fasten the interfaces or waveguide directly to another waveguide or device.

Hereby, the waveguide adapter is creating an interface to avoid rocking or cocking of the waveguide. By avoiding rocking or cocking the electrical performance are increased. Further, the adapter provides a structure, which reduces the electrical degradation caused by any gaps between the waveguide and another waveguide or device, which are to be connected.

The waveguide adapter has two sides, the first side and the second side. Each side has a contact surface. The first side comprises a first contact surface and the second side comprises a second contact surface. The contact surface is the part of the side that is intended to get in contact or mate with the interface of the flange of the waveguide, or is intended to get in contact or mate with the device, which is connected to the waveguide, this may be another waveguide or an external device.

The expressions “mate” or “mating” is to be understood as there is physical engagement between one of the contact surfaces and the flange, or between two contact surfaces of two different waveguide adapters. More general that there is a physical engagement between a contact surface and another element. This physical engagement is substantially preventing relative movement of the waveguide adapter with respect to the waveguide. The word “connect” or “connecting” may be used instead of “mate” or “mating”, where this is more convenient.

The waveguide adapter may be placed against the interface of the flange with the first side turned against the flange, or it may be turned so it is placed against the interface of the flange with the second side turned against the flange, so that either the first contact surface or the second contact surface is mating the flange.

The waveguide adapter may be manufactured to comprise two layers, a first layer and a second layer. The first layer comprises an upper side, which is the side facing away from the second layer, and an underside, which is the side facing against the second layer. The second layer is smaller than the first layer and may form a protrusion on the waveguide adapter. The protrusion also have the effect that is creates a mechanical support for the first layer, strengthening the waveguide adapter, to reduce the risk for the adapter to break.

The second layer forms the second side of the waveguide adapter together with the part of the underside of the first layer not covered by the second layer. The first side of the waveguide adapter is formed of the upper side of the first layer. The second contact surface is substantially the surface of the underside not covered by the protrusion; therefore, the second contact surface is placed on the underside of the first layer.

The second layer is fixed to the first layer. A mechanical support layer between the first layer and the second layer bonding the layers together may do this. Alternatively, the first layer and the second layer may be formed in one piece. It is noted that although the term “layer” is used in this connection, this does not necessarily indicates that the waveguide component is provided as separate elements pieced together as one or more, such as all waveguide components may be provided by producing the waveguide component from a single element.

The waveguide adapter comprises a waveguide opening placed centrally in the waveguide adapter. The waveguide opening is aligned with a similar opening, the waveguide channel, in the waveguide; the waveguide opening is for the wave from the waveguide to pass through the waveguide adapter.

The invention is particularly, but not exclusively, advantageous for obtaining a waveguide adapter, which can be mounted on the flange of a waveguide to form a contact surface that fits to receive another waveguide or another external device to obtain precise alignment and proper connection between the waveguide and another waveguide or external device. Further, the invention has the advantage that the waveguide adapter ensures a connection to another waveguide or another external device reducing rocking or cocking, and reducing the electrical degradation caused by any gaps.

According to an embodiment, the waveguide adapter comprises a RF choke.

In some preferred embodiments, the waveguide adapter comprises an integrated RF choke. The RF choke is designed to prevent electromagnetic leakage in case of the presence of a small gap when connecting or mating the waveguide flange to a waveguide adapter.

Hereby, by using a RF choke, it is ensured that the implementation, using a waveguide adapter for the interface between the waveguide and another device, a non-contact interface is provided, which eliminates the electrical degradation caused by any gaps.

A RF choke can be implemented in having a correct thickness such as a thickness ofn* λ/i, i being an integer, such as a layer of thickness λ/4.

According to an embodiment, the waveguide adapter is configured to mount on the flange of a first waveguide, the one of the first contact surface or the second contact surface not in engagement with the flange is configured to mate with an alternative waveguide adapter mounted on the flange of a second waveguide, when the waveguides are respectively connected by one of the contact surfaces of the waveguide adapter and the alternative waveguide adapter.

Two waveguides, which is to be connected may both have a waveguide adapter mounted on the flange, the two waveguide adapters are then made to fit to each other, so the contact surface of one waveguide adapter mounted on the first waveguide may mate the contact surface of the alternative waveguide adapter mounted on the second waveguide. The two waveguide adapters may not be identical, but made so the contact surfaces facing outwards are mating. The advantage is that having two waveguides, which may not fit together, by mounting a waveguide adapter to the first waveguide and an alternative waveguide adapter to the second waveguide, the waveguides may be made to be able to connect together.

The term “alternative waveguide adapter” covers a second adapter, and is used in situations where more than one waveguide adapter is used. The alternative waveguide adapter may be different from the waveguide adapter of the invention, but also may be the waveguide adapter of the invention. Sometimes the term “second waveguide adapter” is used instead of an “alternative waveguide adapter”, when it is more prudent in the situation. The term “the first waveguide adapter” is sometimes used to cover the waveguide adapter of the invention, and the terms “the first waveguide adapter” and “the second waveguide adapter” may be used to distinguish the waveguide adapters from each other, when more than one waveguide adapter is considered. It is to be understood that the alternative waveguide adapter may have a first side comprising a recess, the second adapter recess, and a second side comprising a protrusion, the second protrusion.

According to an embodiment, the first side of the waveguide adapter comprises an adapter recess.

In one embodiment, the waveguide adapter may not have a recess, and in another embodiment, it may have a recess, an adapter recess. The adapter recess may be created by removing material from the first layer of the waveguide adapter to create an adapter recess.

According to an embodiment, the protrusion of the waveguide adapter is arranged to fit into an second adapter recess of an alternative waveguide adapter, where the dimensions of the second adapter recess of the alternative waveguide adapter is adapted to fit the protrusion.

When two waveguide adapters, which may be mounted on two different waveguides, are mating, to connect the two waveguides together, one waveguide adapter may have a protrusion and the alternative waveguide adapter may have an adapter recess, so that the protrusion fits into the adapter recess. For two identical waveguide adapters this is not possible, therefore the two waveguide adapters are different. The dimensions of the alternative waveguide adapter is modified to that it has an adapter recess, which is big enough to receive the protrusion of the first waveguide. The second adapter recess in the alternative adapter is arranged to receive the protrusion of the waveguide adapter of the invention.

According to an embodiment, wherein the adapter recess of the waveguide adapter is arranged to fit an second protrusion of an alternative waveguide adapter, where the dimensions of the second protrusion of the alternative waveguide adapter is adapted to fit the adapter recess.

In an alternative embodiment, the dimensions of the alternative waveguide is adjusted so the protrusion of the alternative waveguide can fit into the adapter recess of the waveguide adapter. The second protrusion in the alternative adapter is arranged to fit into the recess of the waveguide adapter of the invention.

According to an embodiment, the adapter recess is formed in the first layer, such that the second layer constitutes the bottom of the adapter recess.

When the adapter recess in the first layer is made, material may be removed from the first layer to make a hole going through the first layer, and then the second layer is placed below this hole to create the bottom of the adapter recess.

According to an embodiment, the waveguide adapter is mounted on the flange of the first waveguide with the adapter recess on the first side of the waveguide adapter facing outwards, and an alternative waveguide adapter is mounted on the flange of the second waveguide with the protrusion on the second side facing outwards, and the waveguides are connected by the contact surfaces facing outwards are mating.

There are different embodiments of the waveguide adapter. In one embodiment, the waveguide adapter comprises a substantially flat surface on the first side. In another embodiment, the waveguide adapter comprises an adapter recess on the first side. On the second side, the waveguide adapter comprises a protrusion. The waveguide adapter can be mounted on the flange of a waveguide, so either the first side or the second side it mating the flange, and the other side is pointing away from the flange. The side pointing away from the flange therefore may be substantially flat, and have an adapter recess or have a protrusion.

Therefore the first waveguide may have an adapter mounted with an adapter recess on the surface facing outwards, and the second waveguide may have an adapter mounted with a protrusion facing outwards, and when the contact surface of the adapters are mating the protrusion of one adapter fits into the adapter recess of the other adapter.

The adapter recess may comprise an inner contact surface and an outer contact surface. The inner contact surface and the outer contact surface are substantially perpendicular to the first contact surface. The inner contact surface is placed between the central element and the adapter recess. The outer contract surface is placed between the rim element and the adapter recess. Both the inner contact surface and the outer contact surface are substantially perpendicular to the first contact surface.

When the first contact surface is mating an alternative waveguide adapter, the inner contact surface may be arranged to mate an inner protrusion surface of the alternative waveguide adapter and/or the outer contact surface is arranged to mate an outer protrusion surface of the alternative waveguide adapter.

According to an embodiment, the waveguide adapter is mounted on the flange of the first waveguide with the protrusion on the second side of the waveguide adapter facing outwards, and an alternative waveguide adapter is mounted on the flange of the second waveguide with the adapter recess on the first side facing outwards, and the waveguides are connected by the contact surfaces facing outwards are mating.

The protrusion of the waveguide adapter comprises an inner protrusion surface and an outer protrusion surface. The inner protrusion surface and an outer protrusion surface are substantially perpendicular to the second contact surface. The inner protrusion surface is placed on the inside of the protrusion, on the side facing towards the centre. The outer protrusion surface is placed on the outside of the protrusion, on side facing towards the rim.

In an embodiment, the protrusion further comprises a recess configured to fit with an alignment element of an external device.

When the first contact surface is mating an alternative waveguide adapter, the inner protrusion surface may be arranged to mate an inner recess surface of the alternative waveguide adapter and/or the outer protrusion surface is arranged to mate an outer recess surface of the alternative waveguide adapter.

According to an embodiment, the first layer and the second layer are made of silicon.

Preferably, the first layer and the second layer are made of silicon, but other materials may also be used.

According to an embodiment, a protrusion in the second contact surface is arranged to fit into a flange recess of the flange.

The flange surface usually comprises a recess, the flange recess, and the protrusion of the waveguide adapter is fitting into the flange recess in the flange surface, when the adapter is mounted on the flange with the second side mating the flange.

The flange surface comprises an outer surface outside the flange recess and an inner surface inside the recess. The recess comprises an inner wall and an outer wall. The inner wall is placed between the flange recess and the inner surface. The outer wall is placed between the flange recess and the outer surface.

The inner protrusion surface may be arranged to mate the inner wall of the flange recess in the flange. The outer protrusion surface may be arranged to mate the outer wall of the flange.

By the protrusion mating the inner wall and/or the outer wall an increase stability of the mount may be achieved as well as the alignment between the flange and the waveguide adapter is achieved.

According to an embodiment, the first side is substantially flat.

In one embodiment the first side of the waveguide adapter is substantial flat, this is to be understood that the first side is substantial flat except for holes for i.e. screws, dowels and other holes and that the first side does not have an adapter recess to receive a protrusion from another adapter, waveguide or another external device.

According to an embodiment, the waveguide adapter comprises fixture holes for fixture screws arranged to be aligned with similar fixture holes in the waveguide.

The waveguide adapter comprises holes for screws, when the waveguide is fixed to another waveguide or an external device, screws or bolts going through fixture holes in the waveguide adapter, the waveguides, and possible in external device is used to fix the different pieces together.

According to an embodiment, the waveguide adapter comprises dowel holes for dowel pins arranged to be aligned with dowel pins in the waveguide.

Dowel pins may be used to align the waveguide adapter, the waveguide and possible a second waveguide or external device, therefore there may be dowel holes in the waveguide adapter to be aligned with dowel pins.

However, the dowel holes may not be needed, as structures on the waveguide adapter may be sufficient to align the waveguide adapter and the waveguide. This may be structures like the protrusion, which may fit in the flange recess in the waveguide, where the outer protrusion surface is aligning with the outer wall in the flange recess in an interference fit, and thereby ensuring the waveguide opening is aligning with the waveguide channel in the waveguide. Alternatively, the inner wall of the flange recess may align with the inner protrusion surface.

Also, the waveguide adapter may not need screws or screw holes, as two waveguides may be fastened in a stand, where the positions of the waveguides are determined, and two waveguides may be placed in an aligned position, so they may work together without being fixed together.

According to an embodiment, the waveguide adapter comprises a mechanical support layer connecting the first layer and the second layer.

In the preferred embodiment, the first layer and the second layer are connected together by a mechanical support layer. The mechanical support layer preferable is Silicon dioxide SiO₂. The layers are then joined together by bonding according to well-known processes.

According to an embodiment, the contact surfaces of the waveguide adapter facing outwards from the waveguide are configured to mate a second waveguide or an external device.

The first contact surface and the second contact surface of a waveguide adapter may be configured to mate a second waveguide or an external device. Also the inner protrusion surface, outer protrusion surface, the inner contact surface and the outer contact surface of a waveguide adapter may be configured to mate a second waveguide or an external device.

In one embodiment, the adapter further comprises one or more attachment element(s), such as at least two, wherein the attachment element(s) is arranged in a recess in the adapter (1), and wherein the attachment element(s) is configured for receiving a fixing element.

In one embodiment, the attachment element(s) is in connection with the first layer and the second layer.

In one embodiment, the attachment element(s) is threaded, and preferably the element(s) is made from a metal, a ceramic or a plastic.

In a second aspect, the invention further relates to a method to manufacture a waveguide adapter, comprising the steps:
placing a first layer of silicon on top of a second layer of silicon with a mechanical support layer between to bind the first layer and the second layer together,
removing material from the first layer and second layer to create holes for recesses and/or fixture screws and/or dowel pins,
removing material from the second layer to create a protrusion.

The waveguide adapter may be manufactured by placing a first layer on top of the second layer with a mechanical support layer between. The mechanical support layer is binding the layers together by well-known processes. Material may be removed from the layers to form the recesses, the fixture holes, the dowel holes, the waveguide opening and/or a RF choke. From the second layer material is removed to form the protrusion and to uncover the second contact surface on the underside of the first layer.

In a third aspect, the invention further relates to a waveguide adapter assembly comprising:
a first waveguide adapter according to the first aspect configured to mate with a first waveguide with either of the first contact surface and the second contact surface of the first waveguide adapter;
a second waveguide adapter according to the second aspect configured to mate with a second waveguide with either of the first contact surface and the second contact surface of the second waveguide adapter;
   wherein one of the first contact surface and the second contact surface of the first waveguide adapter not in contact with the first waveguide is configured to mate with the one of the first contact surface and the second contact surface of the second waveguide adapter not in contact with the second waveguide.

In a waveguide assembly where two waveguides are connected, each of the waveguides may mate to a waveguide adapter according to the first aspect of the invention. For each of the waveguide adapters the one of the first contact surface and the second contact surface not in contact with the respective waveguide is configured to mate the other waveguide adapter.

The first, second and third aspects of the present invention may each be combined with any of the other aspects. These and other aspects of the invention will be apparent from and elucidated with reference to the embodiments described hereinafter.

### BRIEF DESCRIPTION OF THE FIGURES

The waveguide adapter according to the invention will now be described in more detail with regard to the accompanying figures. The figures show one way of implementing the present invention and is not to be construed as being limiting to other possible embodiments falling within the scope of the attached claim set.

FIG. 1 shows a waveguide adapter for mounting on a flange of a waveguide.

FIG. 2 shows a waveguide adapter, which have an adapter recess.

FIG. 3 shows an exploded view of the waveguide adapter in FIG. 2.

FIG. 4 shows the waveguide with the flange and a flange recess.

FIG. 5 shows the waveguide adapter of FIG. 1 mounted on the flange.

FIG. 6 shows an exploded view of the waveguide adapter of FIG. 2.

FIG. 7 shows a view with two waveguides with a waveguide adapter between them.

FIG. 8 shows a waveguide adapter of FIG. 7 mounted on the flange, but turned the opposite way than in FIG. 7.

FIG. 9 shows an exploded view of the embodiment of the waveguide adapter mounted on a flange from FIG. 5.

FIG. 10 shows an exploded view of the embodiment, where the waveguide adapter mounted as in FIG. 7.

FIG. 11 shows an embodiment with two waveguide adapters, where one waveguide adapter has a protrusion, which fits into a second adapter recess of the other waveguide adapter.

FIG. 12 shows an embodiment with two waveguide adapters, where the first side of the two waveguide adapters are mating.

FIG. 13 shows an embodiment where the second layer is turned 90 degrees relative to the first layer compared to FIG. 12.

FIG. 14 shows an embodiment where the second side of the waveguide adapter is adapted to fit an external device.

FIG. 15 shows an exploded view of an embodiment where the external device is placed between two waveguides.

FIG. 16-18 shows cross sections of different embodiments of waveguide adapters mounted on a flange.

FIG. 19 shows an embodiment where the waveguide adapter do not have dowels or dowel holes.

FIG. 20 shows a cross section of an embodiment, where the external device is arranged between two mating waveguide adapters.

FIG. 21-23 show cross sections of different embodiments of waveguide adapters connected to external devices.

### DETAILED DESCRIPTION OF AN EMBODIMENT

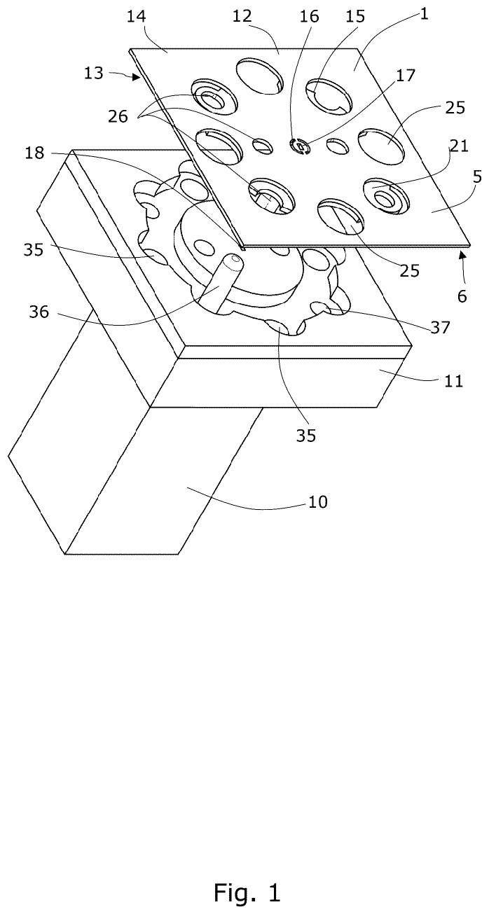

FIG. 1 shows a waveguide adapter 1 for mounting on a flange 11 of a waveguide 10. In FIG. 1, the waveguide adapter 1 is seen from the first side 5, with the second side 6 (not visible) facing towards the waveguide. The waveguide adapter comprises two layers, the first layer 14 and the second layer 15. The second layer can be seen through holes in the first layer. The waveguide comprises a protrusion 21 on the second side; the protrusion is part of the second layer. The first contact surface 12 of the upper side of the first layer comprises a substantially flat surface, which is the surface of the first side except for the holes. Alternatively, the first contact surface 12 may be the part of the surface closest to the rim, or between a circle, substantially formed by the holes, and the edge of the first layer.

The holes in the adapter may be fixture holes 25 for alignment with fixture holes 35 in the waveguide for fixing screws or bolts, or the holes may be dowel holes 26 for alignment with dowels 36 in the waveguide. The dowels may be placed in dowel holes 37 in the flange. In this embodiment, eight identical holes are made in the first layer 14, and then holes, or part holes, in the second layer 15 may be smaller than the holes in the first layer, where the smaller holes usually are dowel holes and the wider holes usually are fixture holes for screws or bolts.

In the centre of the waveguide adapter is a waveguide opening 17, which is the opening through which waves are passing. The waveguide opening 17 is aligned with a waveguide channel 18 in the waveguide 10. In addition, a RF choke 16 is in the waveguide adapter substantially surrounding the waveguide opening 17.

The size of the waveguide adapter may be 13 mm×13 mm with a width of less than 1 mm. But other sizes is also possible depending on the size of the flange of the waveguide.

As illustrated, the RF choke 16 may be formed as a circular recess having a width and a depth in the surface encircling the waveguide opening 17, but other shapes such as elliptical or square may be used. The dimensions of the RF choke 16 (e.g. width and depth) should preferably be matched to the frequency of operation, such as having a length of λ/2 from the waveguide opening 17.

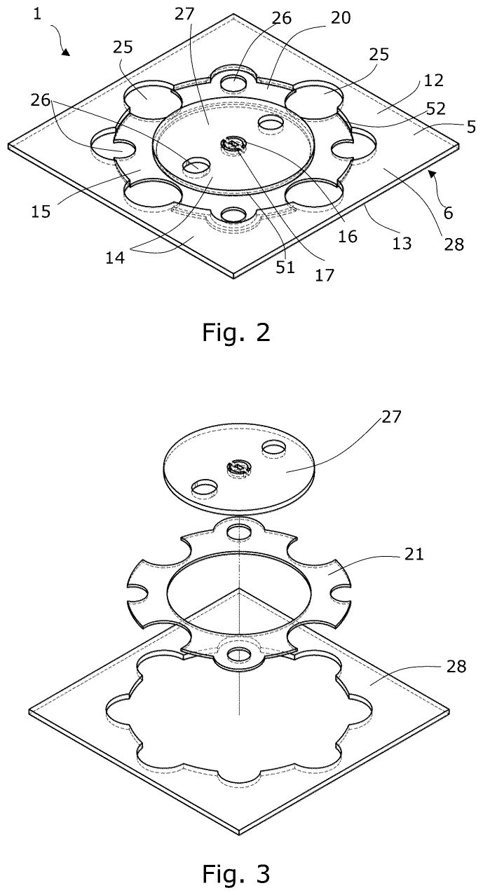

In FIG. 2, a waveguide adapter 1 is shown, which have an adapter recess 20 in the first side 5. The waveguide adapter shown in FIG. 1 does not have an adapter recess in the first side. As can be seen the waveguide adapter comprises two layers, the first layer 14 comprises the central element 27 and the rim element 28, while the second layer 15 is seen through the adapter recess 20, and forms the bottom of the adapter recess. The first contact surface 12, on the upper side of the first layer, comprises the surface of the rim element 28 but may also comprise the surface of the central element 27.

The adapter recess 20 is shown in FIG. 2, and generally in all figures, in a substantially circular form. However, the adapter recess may have any form, square, rectangular, oval, elliptical or any other from imaginable, to fit the protrusion in a surface it is mating, whether it is the flange surface of a waveguide, the surface of another waveguide adapter or the surface any external device. Obviously, the protrusion may similar have different forms, as it typically will substantially have the same or similar form as the adapter recess.

The adapter recess 20 further comprises an inner contact surface 51 and an outer contact surface 52. The inner contact surface 51 is placed between the central element 27 and the adapter recess 20. The outer contract surface 52 is placed between the rim element 28 and the adapter recess 20. Both the inner contact surface 51 and the outer contact surface 52 are substantially perpendicular to the first contact surface 12.

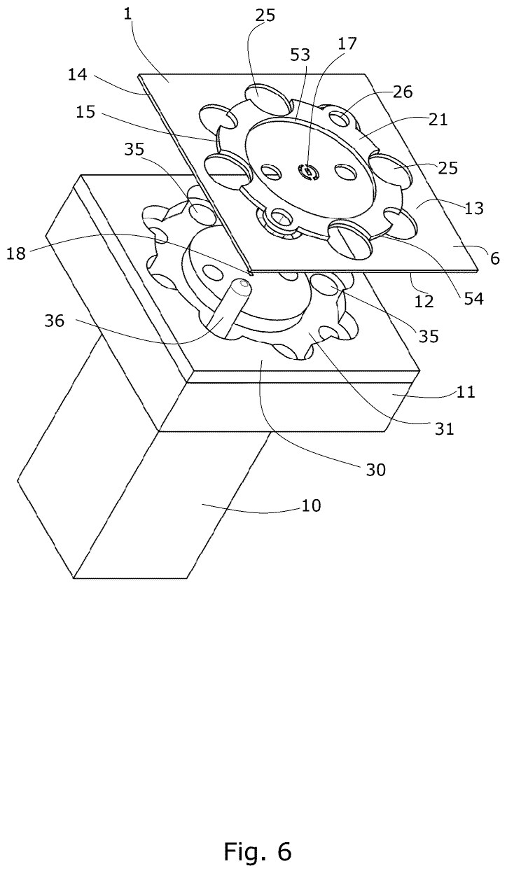

As the second layer 15 is fixed to the first layer 14, the protrusion (21 on FIG. 6) of the second layer goes slightly in over the edge of the adapter recess 20, the protrusion on the second side of a waveguide is therefore larger than the adapter recess 20 of the same waveguide, and do therefore not fit into the adapter recess of a similar waveguide adapter.

FIG. 3 shows an exploded view of the waveguide adapter in FIG. 2, with the central element 27, the rim element 28 and the protrusion 21.

The protrusion 21 is fixed below the central element 27 and the rim element 28. The protrusion is slightly larger than the adapter recess 20, so the edge of the protrusion 21 is fixed by bonding by a mechanical support layer to the underside of the central element 27 and the rim element 28 where they overlap the protrusion, near the edges.

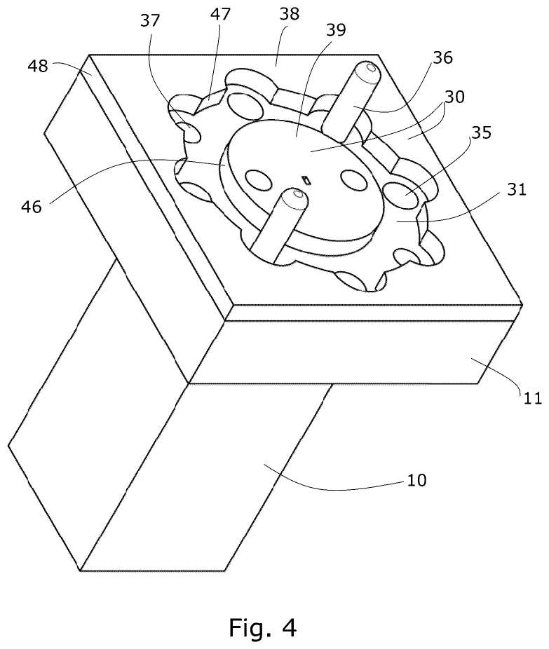

FIG. 4 shows the waveguide 10 with the flange 11, the flange recess 31, the fixture holes 35, the dowels 36, and the dowel holes 37, which may receive dowels from another waveguide, when it is connected to this waveguide. It can be seen that the flange comprises a top layer 48, but whether the flange 11 comprises an added top layer 48 or is made in one piece is not relevant for the invention, and therefore not considered further. Here the outwards side of the top layer comprises the flange surface 30, which may be connected to the first contact surface or second contact surface of the waveguide adapter.

The flange surface 30 comprises an outer surface 38 outside the flange recess 31 and an inner surface 39 inside the recess 31. The flange recess 31 comprises an inner wall 46 and an outer wall 47. The inner wall 46 is placed between the flange recess 31 and the inner surface 39. The outer wall 47 is placed between the flange recess 31 and the outer surface 38. In inner and outer walls are substantially perpendicular to the flange surface 30.

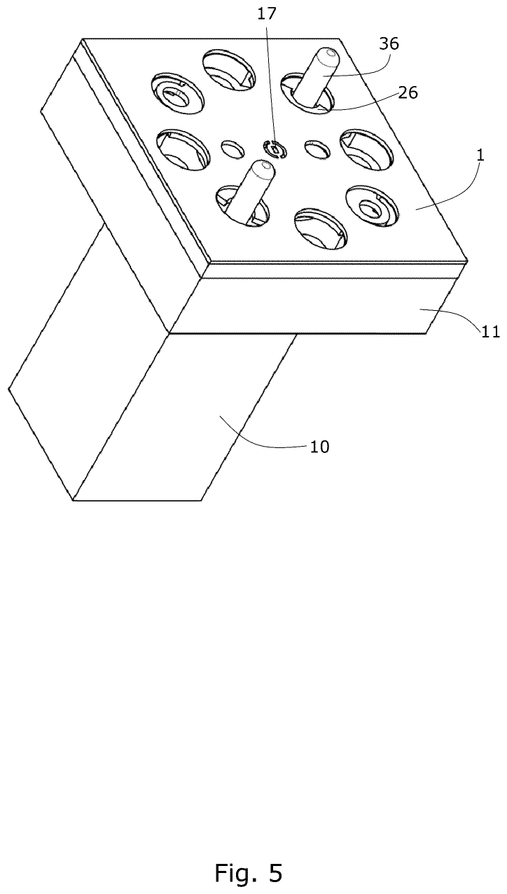

FIG. 5 shows the waveguide adapter 1 of FIG. 1 mounted on the flange 11 of the waveguide 10. Dowels 36 are going through the dowel holes 26 aligning the waveguide adapter 1 with the flange 11 ensuring that the waveguide opening 17 is aligned with a similar waveguide channel in the waveguide.

FIG. 6 shows an exploded view of the waveguide adapter 1 of FIG. 2 with the protrusion 21. Here the waveguide adapter is seen from the second side 6. In this case, the first side turns towards the waveguide 10, and it is therefore the first contact surface 12, which is mating the flange surface 30, while the second contact surface 13 may be prepared to mate another waveguide or external component.

The protrusion 21 further comprises an inner protrusion surface 53 and an outer protrusion surface 54. The inner protrusion surface 53, which is substantially perpendicular to the second contact surface 13, is placed on the inside of the protrusion 21, on the side facing towards the centre. The outer protrusion surface 54, which is substantially perpendicular to the second contact surface 13, is placed on the outside of the protrusion 21, on side facing towards the rim.

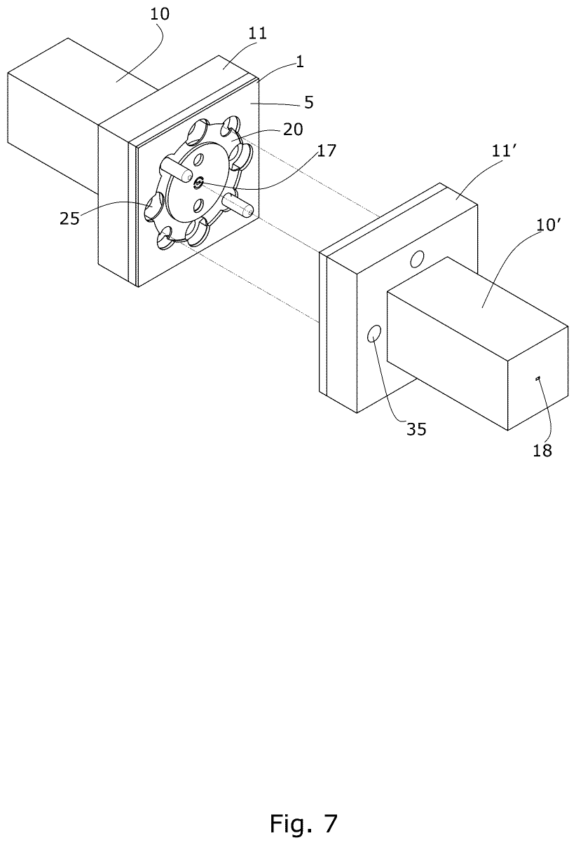

FIG. 7 shows a view with two waveguides, the first waveguide 10 and the second waveguide 10′, with a waveguide adapter 1 between them. The two waveguides are identically. A waveguide adapter 1 is mounted on the flange 11 of the first waveguide 10, while no waveguide adapter is mounted on the second waveguide 10′. The second side of the adapter is mating the flange 11 of the first waveguide 10, while the first side 5 of the waveguide adapter is facing the second waveguide 10′. The two waveguides can be assembled by the first side 5 mating the flange 11′ of the second waveguide 10′. The fixture holes 25, 35 is going through the waveguide adapter and the flanges, as can be seen on the backside of the second flange 11′, and a screw or a bolt going through these holes can fix the two waveguides 10, 10′ and the adapter 1 together. Also the waveguide channel 18 is seen on the bottom of the second waveguide 10′. The waveguide channel goes all the way through the waveguides, so waves can pass through the waveguide channel 18 of one waveguide, through the waveguide opening 17 in the waveguide adapter and through the waveguide channel 18 in the other waveguide.

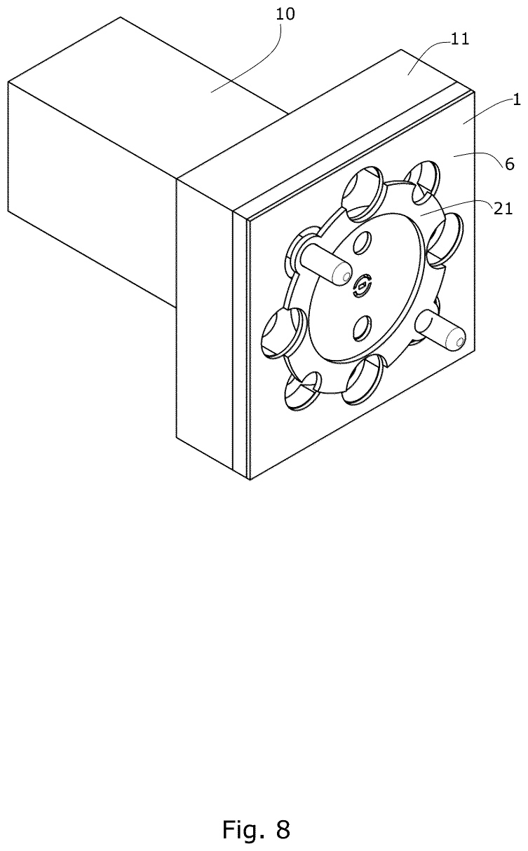

FIG. 8 shows an embodiment, where the waveguide adapter 1 is mounted on the flange 11 of the waveguide 10, but the waveguide adapter is turned the opposite way than in FIG. 7, so the first side with the adapter recess in FIG. 8 is turned inwards to the waveguide 10 and is mating the flange 11. While the second side 6 with the protrusion 21 is turned outwards, prepared to mate another waveguide or external device.

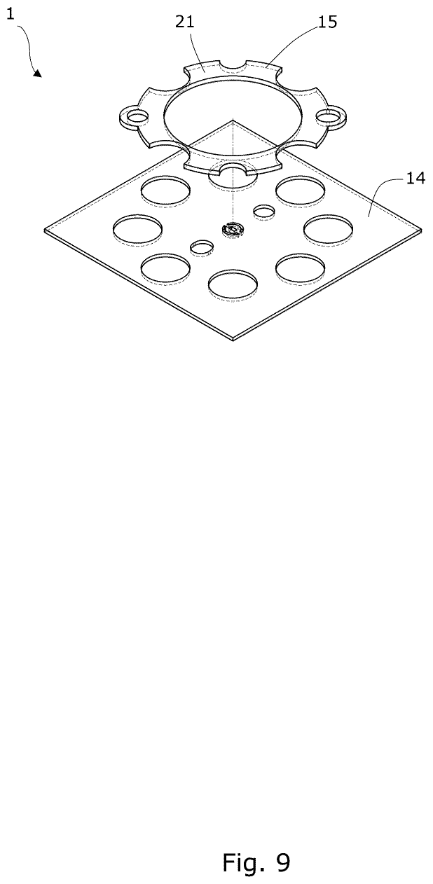

FIG. 9 shows an exploded view of the embodiment of the waveguide adapter 1, where the first layer 14 is formed as a flat piece without a recess, and the second layer 15, forming the protrusion 21, is to be fixed to the first layer in the embodiment of the waveguide adapter 1 also shown in FIG. 5.

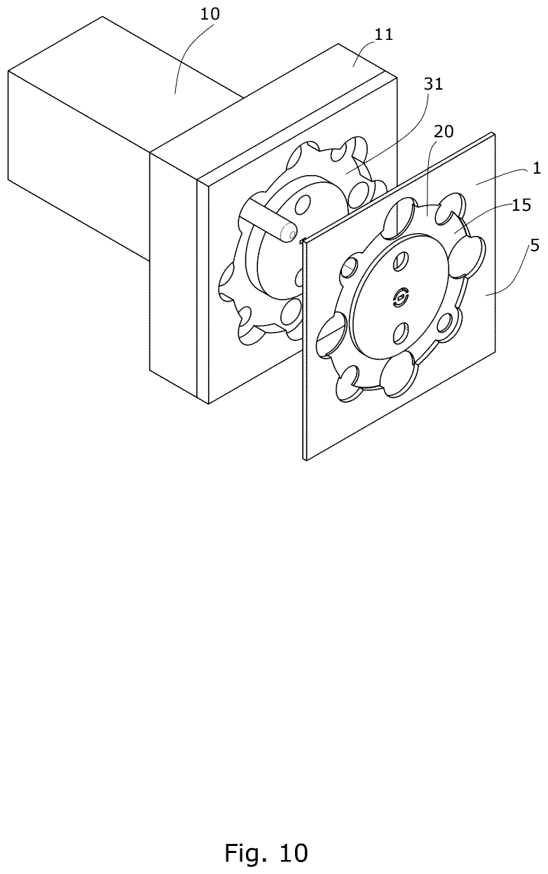

FIG. 10 shows an exploded view of the embodiment, where the waveguide adapter 1 is to be mounted on the flange 11, with the second side facing towards the flange 11, so when the waveguide adapter 1 is mated with the flange 11, the protrusion, formed of the second layer 15, is fitting into the flange recess 31 of the flange 11. The first side 5, with the adapter recess 20, facing away from the flange is prepared to mate another waveguide adapter, waveguide or external device.

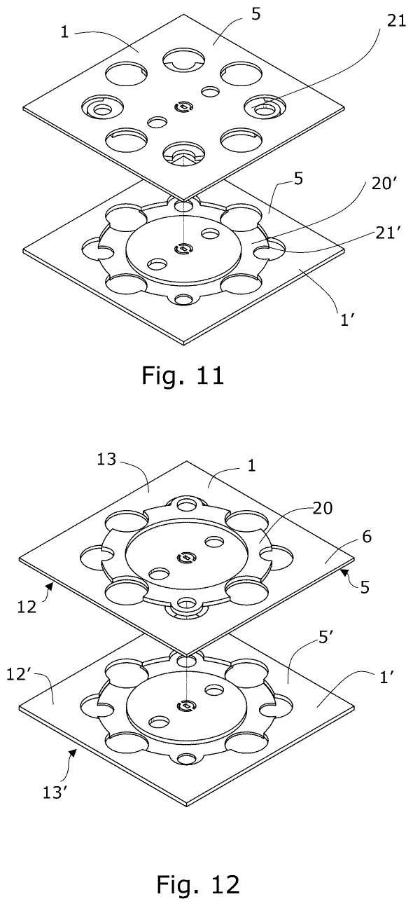

FIG. 11 shows an embodiment with two waveguide adapters 1, 1′. One waveguide adapter 1 has a protrusion 21, which fits into the second adapter recess 20′ of the alternative waveguide adapter 1′. The alternative waveguide adapter 1′ has different dimensions than the first waveguide adapter 1. The second protrusion 21′ on the second side of the alternative waveguide adapter 1′ is larger than the protrusion 21 on the first waveguide adapter 1. The first waveguide adapter 1 may be mounted on a waveguide and the alternative waveguide adapter 1′ may be mounted on another waveguide, and are mated together.

FIG. 12 also shows an embodiment with two waveguide adapters 1, 1′. However, in this case the first sides 5, 5′ of the two waveguide adapters are mating. In this case the two waveguide adapters may be identical. For each waveguide adapter 1, 1′ the protrusion 21 points away from the other waveguide adapter and the second side 6 of the two adapters may be ready to mate a flange of a waveguide.

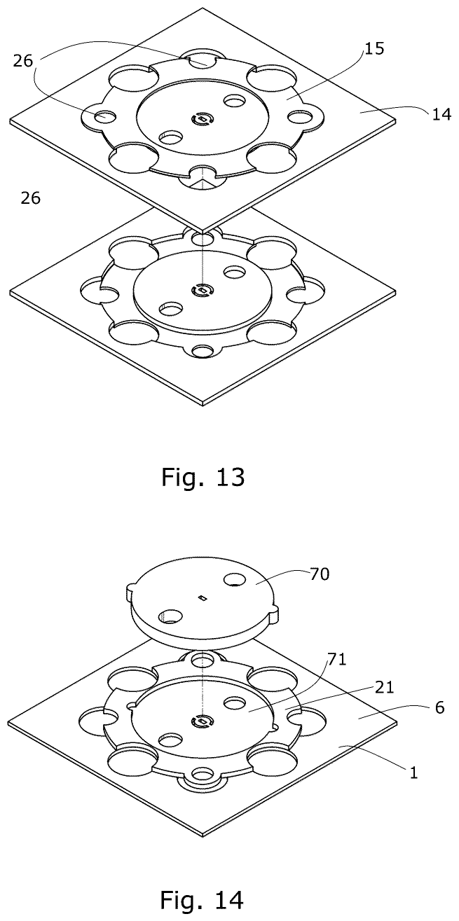

FIG. 13 shows an embodiment where the second layer 15 is turned 90 degrees relative to the first layer 14 compared to FIG. 12. It makes a difference for the placement of the dowel holes 26 and the fixture holes 25. The first layer may be formed to have identical dowel holes and fixture holes, and then the second layer may be formed to adapt the holes, especially the dowel holes to be formed in full or only partly.

FIG. 14 shows an embodiment where the second side 6 of the waveguide adapter is adapted to fit an external device 70. The external device fits into the additional recess 71 in the protrusion 21 on the second side 6 of the waveguide adapter. The external device may comprise alignment element(s) 74, configured to fit with a recess in the protrusion 21 of the waveguide adapter, in order to facilitate the alignment between the external device 70 and the adapter 1.

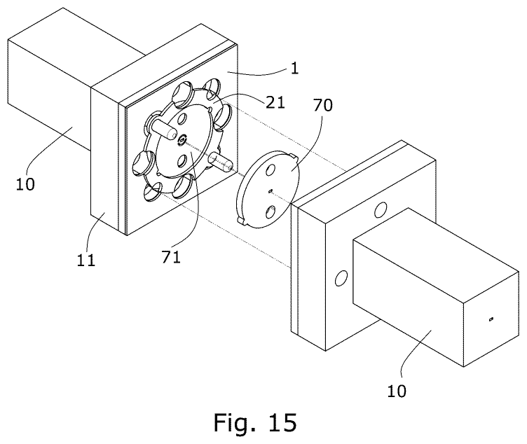

FIG. 15 shows an exploded view of an embodiment, where the external device 70 is placed between two waveguides 10, 10′. One of the waveguides have a waveguide adapter 1 mounted on the flange 11. The second side 6 of the waveguide adapter is facing the external device 70 with fits into the additional recess 71 in the protrusion 21.

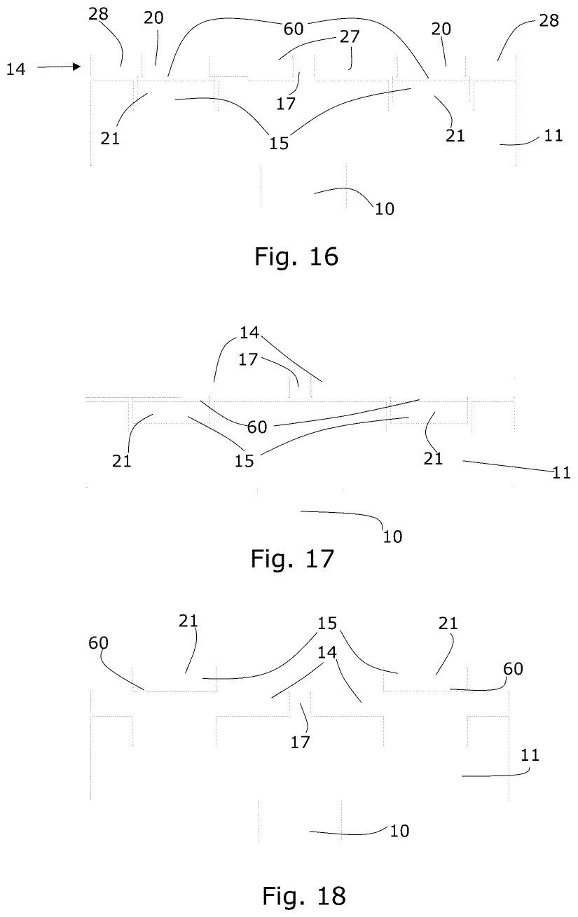

FIG. 16-18 shows cross sections of waveguide adapters mounted on a flange 11 of a waveguide 10. In FIG. 16, the waveguide adapter is of the embodiment shown in FIG. 1 with the protrusion 21, the adapter recess 20, the central element 27, the rim element 28 and the waveguide opening 17. The waveguide adapter comprises a first layer 14 and a second later 15 and the two layers are joined together by a mechanical support layer 60. The waveguide adapter is mounted on the flange 11 of a waveguide 10.

In FIG. 17 is shown the embodiment of the waveguide adapter shown in FIG. 1, without an adapter recess 20. The second side, with the protrusion 21, mates the flange 11 of the waveguide 10. The waveguide adapter comprises the first layer 14 and the second layer 15; the two layers are bonded together by the mechanical support layer 60.

In FIG. 18 is shown the embodiment, where the same waveguide as shown in FIG. 17 is turned around, so the first side is mating the flange 11, and the second side, with the protrusion 21, is facing outwards, away from the waveguide 10. The waveguide adapter comprises the first layer 14 and the second layer 15, the two layers boned together by the mechanical support layer 60.

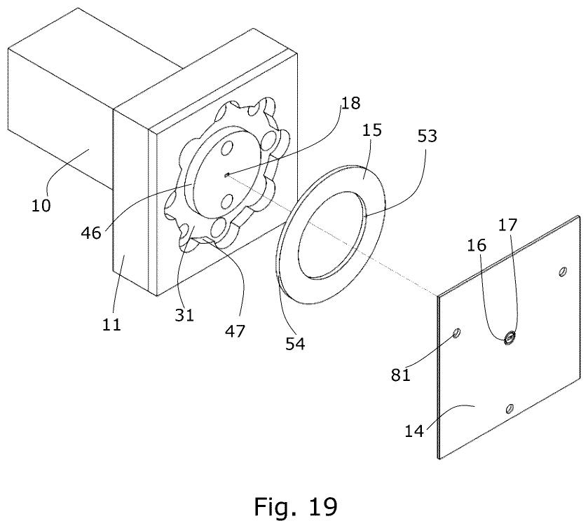

FIG. 19 shows an exploded view of an embodiment, where the waveguide adapter do not have dowels or dowel holes, screws or screw holes. The first layer 14 of the waveguide adapter is basically a flat plate with the waveguide opening 17 and the RF choke 16. However, in an alternative embodiment the first layer may have an adapter recess. The first layer also have three alignment holes 81 for alignment with protrusions from another adapter/component. These holes are arbitrarily shaped/positioned. The second layer 15 is a circular formed ring, without holes, forming the protrusion 21, which fits into the flange recess 31, the protrusion comprise an outer protrusion surface 54. The outer protrusion surface 54 is aligning with the outer wall 47, and thereby ensuring the waveguide opening is aligning with the waveguide channel in the waveguide. Alternatively, the inner wall 46 may align with the inner protrusion surface 53.

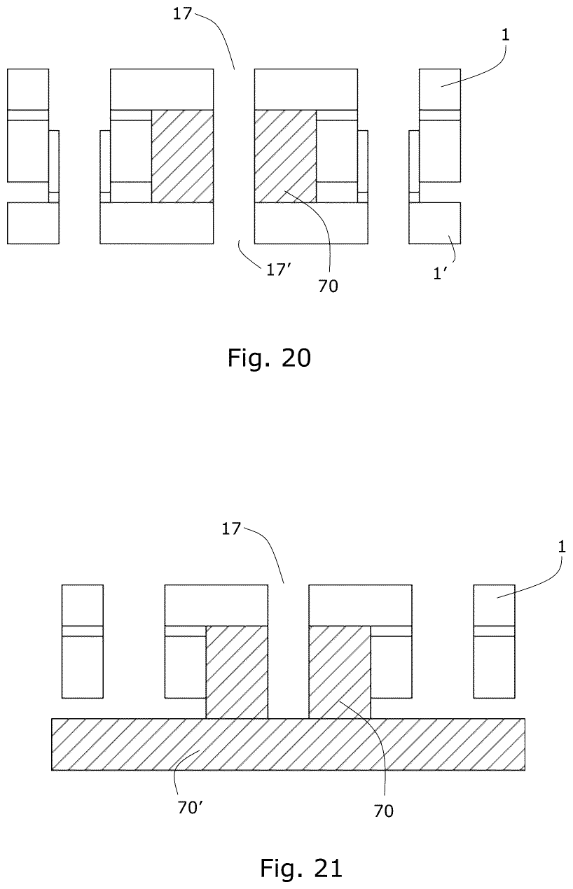

FIG. 20 shows a cross section of an embodiment, where the waveguide adapter 1 is mating with the alternative waveguide adapter, and wherein the external device (70) is arranged between the waveguide adapter 1 and the alternative waveguide adapter 1′. By this configuration, the embedded external device may then be connected to a waveguide flange. The external device may have a through going hole (in FIG. 20 illustrated with a through going hole).

FIG. 21 shows a cross section of an embodiment, where the waveguide adapter 1 is connected to the external device 70, and wherein the external device 70 further is connected to another external device 70′. In illustrated embodiment, the external device acts as an interposer providing an electrical connection between the another external device 70′ and the waveguide opening 17 of the adapter 1. Further, the external device 70 may further provide an electrical connection between the another external device 70′ and the flange 11′ of a second waveguide (not illustrated). In the illustrated embodiment, the another external device 70′ may be an antenna.

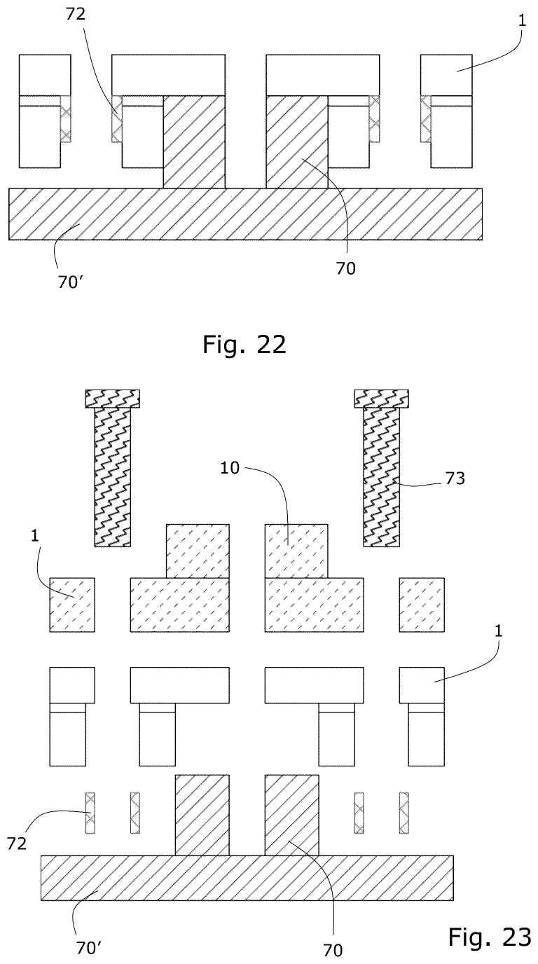

FIG. 22 shows an alternative embodiment of FIG. 21, where attachment elements 72 are arranged in the adapter 1 and used to fixate the waveguide adapter 1 to a flange of another waveguide (not illustrated) or to another external waveguide component. The attachment elements are arranged in a recess in the adapter and in connection with the first and/or section layer(s). The attachment elements 72 are configured to fit with fixing elements 73 (not illustrated). Preferably, attachment elements are arranged in pairs of two.

FIG. 23 shows an exploded cross section view of an alternative embodiment of FIG. 22, where each of the two fixing elements 73 are configured to fit tightly between two attachment elements. Preferably, the attachment elements and the fixing elements are threaded or snap-on. In some embodiments, the attachment elements and the fixing elements are made of metal, plastic, ceramic or a combination. In other embodiments, the fixing elements are made from a different material than the attachment elements.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A waveguide adapter for mounting on a flange of a waveguide or for coupling to an external device, the waveguide adapter comprising;
a first side and a second side;
the first side comprising a first contact surface and the second side comprising a second contact surface
a first layer and a second layer, wherein the first layer comprises the first contact surface and the second contact surface,
the second layer is fixed to the first layer and comprises a protrusion on the second side of the waveguide adapter, and
a waveguide opening.

2. The waveguide adapter according to claim 1, wherein the waveguide adapter comprises a RF choke.

3. A waveguide adapter according to claim 1, wherein the waveguide adapter is configured to mount on the flange of a first waveguide, the one of the first contact surface or the second contact surface not in engagement with the flange is configured to mate with an alternative waveguide adapter mounted on a flange of a second waveguide, when the waveguides are respectively connected by one of the contact surfaces of the waveguide adapter and the alternative waveguide adapter.

4. A waveguide adapter according to claim 1, wherein the first side of the waveguide adapter comprises an adapter recess.

5-9. (canceled)

10. The waveguide adapter according to claim 1, wherein the first layer and the second layer are made of silicon.

11. The waveguide adapter according to claim 1, wherein a protrusion in the second contact surface is arranged to fit into a flange recess of the flange.

12. The waveguide adapter according to claim 1, wherein the first side is substantially flat.

13. The waveguide adapter according to claim 1, wherein the waveguide adapter comprises fixture holes for fixture screws arranged to be aligned with similar fixture holes in the waveguide.

14. The waveguide adapter according to claim 1, wherein the waveguide adapter comprises dowel holes for dowel pins arranged to be aligned with dowel pins in the waveguide.

15. The waveguide adapter according to claim 1, wherein the waveguide adapter comprises a mechanical support layer connecting the first layer and the second layer.

16. The waveguide adapter according to claim 1, wherein the waveguide adapter configured to mate a second waveguide or an external device.

17. The waveguide adapter according to claim 11, wherein the protrusion further comprises a recess, configured to fit with an alignment element of an external device.

18. The waveguide adapter according to claim 1, wherein the adapter further comprises one or more attachment element(s), such as at least two, wherein the attachment element(s) is arranged in a recess in the adapter, and wherein the attachment element(s) is configured for receiving a fixing element.

19. The waveguide adapter according to claim 18, wherein the attachment element(s) is in connection with the first layer and the second layer, and wherein the attachment element(s) preferably is threaded.

20. A method to manufacture a waveguide adapter, comprising:
placing a first layer of silicon on top of a second layer of silicon with a mechanical support layer between to bind the first layer and the second layer together,
removing material from the first layer and second layer to create holes for recesses and/or fixture screws and/or dowel pins, and
removing material from the second layer to create a protrusion.

21-23. (canceled)

24. The waveguide adapter according to claim 1, wherein the waveguide opening is configured to be aligned with a waveguide channel in the waveguide.

25. The waveguide adapter according to claim 1 wherein the external device is an antenna.

26. The waveguide adapter according to claim 1, wherein the waveguide adapter is configured to fit with alignment elements in the external device.

27. The waveguide adapter according to claim 1, wherein the waveguide adapter is configured to form an interference fit with the external device.

28. The waveguide adapter according to claim 1, wherein the waveguide adapter is configured to mate a second waveguide and wherein an external device is arranged between and coupled to said first and second waveguide adapters.
